(19) United States
(12) Patent Application Publication
(10) Pub. No.: US 2008/0219542 A1
(43) Pub. Date: Sep. 11, 2008

(54) Systems for characterizing localization in biological cells

(76) Inventors: Vladimir Temov, Los Gatos, CA (US); Ilya Ravkin, Palo Alto, CA (US)

Correspondence Address: KOLISCH HARTWELL, P.C., 520 SW YAMHILL STREET, Suite 200, PORTLAND, OR, 97204, US

(21) Appl. No.: 11/406,815

(22) Filed: Apr. 18, 2006

Related U.S. Application Data
(60) Provisional application No. 60/672,580, filed on Apr. 18, 2005.

(51) Int. Cl. G06K 9/00

(52) U.S. Cl. 382/133

(57) ABSTRACT

Systems for characterizing localization in biological cells.

### CROSS-REFERENCE TO PRIORITY APPLICATION

This application claims the benefit under 35 U.S.C. § 119(e) of U.S. Provisional Patent Application Ser. No. 60/672,580, filed Apr. 18, 2005, which is incorporated herein by reference in its entirety for all purposes.

### CROSS-REFERENCES TO OTHER MATERIALS

This application incorporates by reference in their entirety for all purposes the following U.S. patent application Ser. Nos. 09/549,970, filed Apr. 14, 2000; Ser. No. 09/694,077, filed Oct. 19, 2000; Ser. No. 10/120,900, filed Apr. 10, 2002; Ser. No. 10/273,605, filed Oct. 18, 2002; Ser. No. 10/282,904, filed Oct. 28, 2002; Ser. No. 10/282,940, filed Oct. 28, 2002; Ser. No. 10/444,573, filed May 23, 2003; Ser. No. 10/901,942, filed Jul. 28, 2004; Ser. No. 10/942,322, filed Sep. 15, 2004; and Ser. No. 11/039,077, filed Jan. 18, 2005.

This application also incorporates by reference in their entirety for all purposes the following U.S. provisional patent applications Ser. No. 60/537,454, filed Jan. 15, 2004; and Ser. No. 60/645,583, filed Jan. 17, 2005.

This application also incorporates by reference in its entirety for all purposes the following U.S. Pat. No. 5,989,835.

This application also incorporates by reference in their entirety for all purposes the following publications: Kenneth R. Castleman, DIGITAL IMAGE PROCESSING (1996); and John Goutsias, Luc M Vincent, Dan S Bloomberg, Eds., MATHEMATICAL MORPHOLOGY AND ITS APPLICATIONS TO IMAGE AND SIGNAL PROCESSING (2000).

### INTRODUCTION

In many areas of research, there is a need to measure the amount of material in an object that emits light, for example, the amount of fluorescent material contained in a biological cell or in a compartment of a biological cell. Such objects can be observed using an opto-electronic system that represents a field of view containing the object by an image consisting of discrete digitized pixels. Digitization commonly is performed to 8-16 bit precision (8 bits corresponds to 2⁸=256 possible values, and 16 bits corresponds to 2¹⁶=65,536 different values). Images digitized to two or more bits are termed “gray-scale” images, since they can include black (or darkest), white (or lightest), and 2^{N-1} levels in-between.

A given field of view can be imaged in one or more different optical modalities, for example, different spectral (color) ranges, fluorescence or brightfield, different polarization states, etc. Each of the acquired images can represent different attributes of the field containing the object of interest.

The task of measuring the amount of material in (or the amount of light emitted by) an object may require a knowledge of which pixels in the image belong to the object in question and which pixels do not. A common way of dealing with this problem is to partition (segment) the image into two sets of pixels: a first set corresponding to the object, and a second set corresponding to the complement of the object (non-object). One way of representing such a partition is by a mask (binary image) that is the same size as the original image and that contains “1” at the positions that correspond to the object and “0” at all other positions. If such segmentation is done, total intensity can be measured simply by adding the pixel values of the original image for the pixels that have “1” in the corresponding pixels of the mask.

What is the basis for such segmentation? Typically, an image that most closely represents the geometry of the object is chosen and then converted by known image-processing methods to the mask. This procedure may be aided by special processing (staining) of the specimen, for example, staining nuclei (or other organelles) of cells (if the nucleus (or other organelle) is the object of interest), staining plasma membranes of cells (if the whole cell is the object of interest), and so on. Image processing may involve steps such as low-frequency (background) removal, top-hat transform, thresholding, etc. In the last stage of processing pixels with values higher than some predetermined value are assigned “1” in the mask, and pixels with values equal to or lower than the predetermined value (i.e., all other pixels) are assigned “0” in the mask.

Several factors can complicate the conversion of gray-scale images, even of well-defined objects, to (binary) masks. These factors may include distortions caused by the process of sensing the image with an opto-electronic system. Specifically, point sources of light in the object are smeared in the image, becoming diffuse distributions, known as point-spread functions. These factors also may include uncertainties caused by the considerable thickness of many physical objects. Specifically, the flat representations of such objects in images can make it difficult to find the outlines of the objects, especially since the outlines can vary at different heights through the objects, yet they end up superimposed in the image.

There is no good way of determining if segmentation is done correctly. Typically, in image analysis, segmentation is judged by a human. The human eye is very good at perceiving high-level features of images. However, when it comes to outlining smooth and fuzzy objects, the eye has no basis for drawing the outline a little wider or a little narrower.

### SUMMARY

The present teachings provide systems for characterizing localization in biological cells.

### BRIEF DESCRIPTION OF THE DRAWINGS

FIG. 1 is a schematic view showing a series of images of the same field of view taken in different optical modalities.

FIG. 2 is a graph showing intensity profiles through an object, including original profiles (blue and green), indicator function profile (red), and mask (black).

FIG. 3 is a set of processed photographs showing the use of indicator functions in the analysis of a cytoplasm-to-nucleus translocation assay. The left panel corresponds to a negative state of the assay, in which stained proteins are localized predominantly in the cytoplasm. The right panel corresponds to a positive state of the assay, in which stained proteins are localized predominantly in the nucleus.

### DETAILED DESCRIPTION

The present teachings provide systems, including methods, apparatus, compositions, and kits, for characterizing localization in biological cells. The systems thus may be used to analyze images of cells, including the intensities (and/or other properties) of objects in the images. The systems may include preparing; positioning, treating, and/or analyzing samples, among others. These methods also may include using such analysis to monitor and study the joint distributions and/or translocation of subcellular components, including but not limited to cytoplasm-to-nucleus translocation, nucleus-to-cytoplasm translocation, cell-membrane-to-cytoplasm translocation, and cytoplasm-to-cell-membrane translocation, among others.

Preparing samples, as used here, may include, among others, (1) selecting, separating, enriching, growing, modifying, and/or synthesizing a composition, a cellular component, a cell, a tissue, and/or any other assay component, among others, (2) selecting, forming, and/or modifying sample carriers and/or sample containers, such as coded carriers and/or multiwell systems, respectively, (3) associating samples and sample carriers, or mixtures thereof, and/or (4) labeling samples, or sample components, for example, by associating them with dyes, luminophores, and so on, via any suitable method. Further aspects of exemplary coded carriers for samples, and approaches for attaching samples to coded carriers, are described in the U.S. patent applications listed above under Cross-References, which are incorporated herein by reference, particularly Ser. No. 09/549,970, filed Apr. 14, 2000; Ser. No. 09/694,077, filed Oct. 19, 2000; Ser. No. 10/120,900, filed Apr. 10, 2002; and Ser. No. 10/273,605, filed Oct. 18, 2002. Further aspects of multiwell systems that may be suitable are described in the U.S. patent applications listed above under Cross-References, which are incorporated herein by reference, particularly Ser. No. 10/282,940, filed Oct. 28, 2002. Further aspects of samples that may be suitable are described in the U.S. patent applications listed above under Cross-References, which are incorporated herein by reference, particularly Ser. No. 09/694,077, filed Oct. 19, 2000; Ser. No. 10/120,900, filed Apr. 10, 2002; Ser. No. 10/444,573, filed May 23, 2003; and Ser. No. 10/942,322, filed Sep. 15, 2004.

Positioning samples, as used here, may include positioning the samples (and/or any associated sample carriers) for treatment and/or analysis, among others. Such positioning may include, among others, (1) mixing samples, (2) dispensing samples at treatment and/or analysis sites, and/or (3) dispersing samples at treatment and/or analysis sites, for example, to allow access to the samples and/or visualization of the samples, respectively. Further aspects of dispensing and dispersing samples attached to coded carriers are described in the U.S. patent applications listed above under Cross-References, which are incorporated herein by reference, particularly U.S. patent application Ser. No. 10/901,942, filed Jul. 28, 2004.

Treating samples, as used here, may include exposing the samples to some condition, such as a chemical (e.g., a candidate modulator), a temperature, a concentration (e.g., an ion concentration, such as hydrogen ion (pH), salt ion, etc.), and/or the like, and/or a change thereof. Further aspects of treating samples are described in the U.S. patent applications listed above under Cross-References, which are incorporated herein by reference, particularly Ser. No. 09/549,970, filed Apr. 14, 2000; Ser. No. 09/694,077, filed Oct. 19, 2000; Ser. No. 10/120,900, filed Apr. 10, 2002; and Ser. No. 10/444,573, filed May 23, 2003.

Analyzing samples, as used here, may include observing and/or measuring, qualitatively and/or quantitatively, a condition of the sample (e.g., size, mass, identity, etc.,) and/or a condition caused by the sample (e.g., depletion of an enzyme substrate, production of an enzyme product, etc.), using any suitable method(s) (e.g., optical (imaging, absorption, scattering, luminescence, photoluminescence (e.g., fluorescence or phosphorescence), chemiluminescence, etc.), magnetic resonance, and/or hydrodynamics, among others). Such analyzing further may include detecting and/or interpreting a presence, amount, and/or activity of the sample, or a modulator thereof, including agonists and/or antagonists, and/or determining trends or motifs from the analysis of multiple samples. Such analyzing further may include determining and/or analyzing the joint distribution of two or more stains and/or other reporters of location and/or activity in biological systems, for example, for use in translocation assays, among others. Further aspects of analyzing samples (and their carriers) are described in the U.S. patent applications listed above under Cross-References, which are incorporated herein by reference, particularly Ser. No. 10/120,900, filed Apr. 10, 2002; Ser. No. 10/273,605, filed Oct. 18, 2002; Ser. No. 10/282,940, filed Oct. 28, 2002; and Ser. No. 11/039,077, filed Jan. 18, 2005.

### I. OVERVIEW

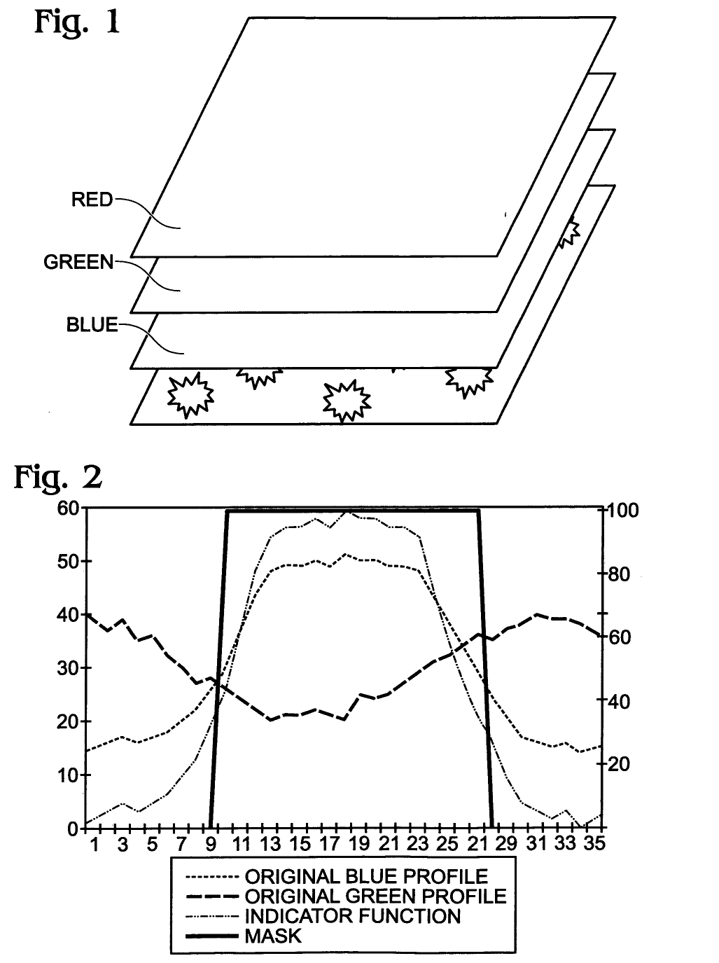

FIG. 1 gives a sample context for the application of the method. A field of view contains objects, for example, biological cells. The objects may be stained to fluoresce at two or more wavelengths. The field of view is acquired at these wavelengths. Different fluorochromes may preferentially label different substances/compartments in cells. For example, in FIG. 1, blue color may correspond to preferentially labeled components, such as DNA, that can be localized to the nucleus, and green color may correspond to preferentially labeled components, such as proteins, that can be localized in the cytoplasm or in the nucleus of a cell.

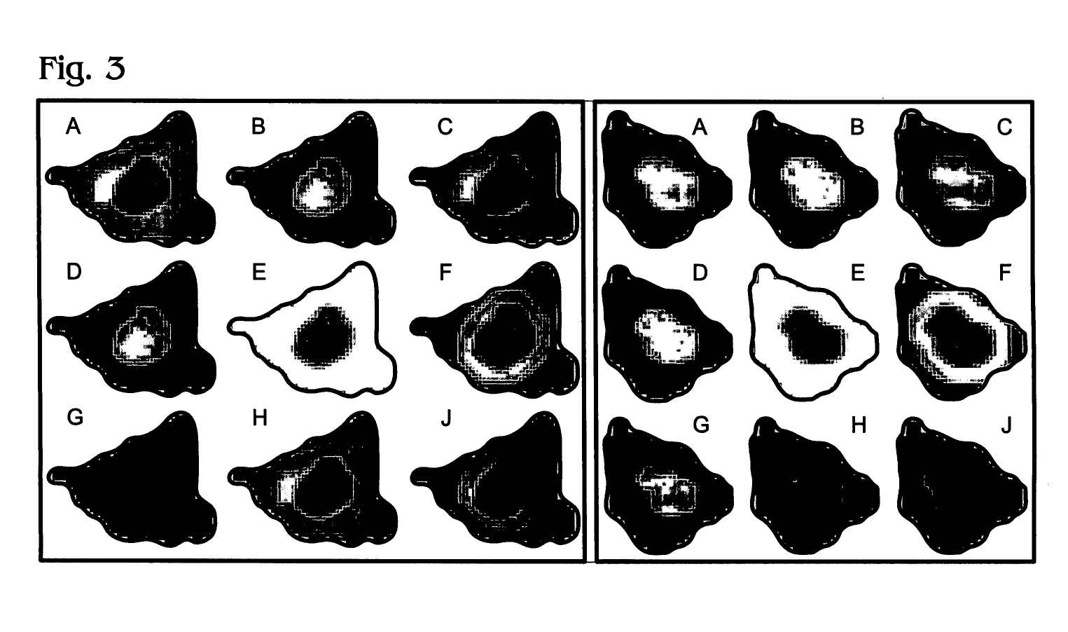

FIG. 2 gives a representation of the images by their intensity profiles measured along a straight line through an object of interest (e.g., along a straight line bisecting a cell). Suppose the task is to measure the amount of fluorescence emitted by proteins in the nucleus of a cell. As described above, the conventional approach is first to use the blue (e.g., nuclear) profile to generate a mask of the nucleus (object of interest), shown in black, and then to integrate intensities under the green (e.g., variable or translocatable) profile within this mask.

The approach presented herein, instead, is to use the blue profile to generate an “indicator function,” shown in red. This name was given because the function indicates the certainty we have in that a pixel belongs to the object. The indicator function may be produced by scaling the blue profile according to a desired metric, for example, to the range [0-1], or [0-100] (in percent), or [0-(2^{N}−1)] (for convenience of representation as an N-bit image). The total or integrated intensity of green in the object then can be produced by integrating green in the whole image, using the indicator function as weight.

The application of this approach does not require having two measured images, green and blue in this example. It can be applied to a single image as well. In this case, the image that generates the indicator function and the image that is being integrated are the same image.

The systems described herein optionally can be used in connection with other imaging systems, for analysis of any suitable images, or portions thereof, including organelles, single cells, sets of cells, tissues, and so on. These other imaging systems can include, among others, individual vs. global analysis, partitioning into components, intensity normalization, preprocessing and artifact removal, and so on. These other imaging systems can include, among others, any systems described in the following U.S. patent applications, which are incorporated herein by reference in their entirety for all purposes: U.S. patent application Ser. No. 10/282,904, filed Oct. 28, 2002; U.S. Provisional Patent Application Ser. No. 60/645,583, filed Jan. 17, 2005; U.S. patent application Ser. No. 11/039,077, filed Jan. 18, 2005.

The systems described herein may have one or more advantages: avoiding possible errors of segmentation, increased speed, better scalability with magnification, and/or others.

### II. APPLICATION TO CYTOPLASM-TO-NUCLEUS TRANSLOCATION ASSAYS

This example describes an exemplary application of the indicator function method to an exemplary translocation assay: cytoplasm-to-nucleus translocation; see FIG. 3.

II.A Background

The organization and dynamics of molecules and supramolecular assemblies plays an important role in the function of cellular systems. Eucaryotic cells, in particular, are highly organized, with many structurally and/or functionally related components organized into specific locations or compartments such as organelles. For example, selected cellular components associated with energy production in eucaryotic cells are organized into mitochondria, while selected cellular components associated with cellular control and inheritance are organized into the nucleus. Eucaryotic cells, more generally, may include a number of different organelles or compartments, organized for a number of different functions, including the nucleus, mitochondria, chloroplasts, lysosomes, peroxisomes, vacuoles, Golgi apparatus, rough and smooth endoplasmic reticulum, centrioles, plasma membrane, nuclear envelope, endosomes, secretory vesicles, and so on.

The components of these different compartments, and of cells and biological organisms in general, may be highly dynamic. Thus, specific molecules may diffuse and/or be actively transported between different regions in the cell and/or between the cell and the extracellular medium. In some cases, molecules may move, or translocate, from one compartment to another, in response to changes in cell cycle, cell signaling (e.g., hormones), disease state, and so on. Moreover, in the case of molecules such as enzymes, the mechanisms that control such distribution and dynamics may be independent of the mechanisms that control or effect catalysis, meaning that they may provide unique, previously unexploited targets for candidate drugs, potentially allowing compounds with similar functionalities (such as kinases) to be targeted based on dissimilar localization or translocalization signals or behavior. Significantly, many molecules potentially associated with disease states, such as transcription factors and kinases, translocate, particularly from cytoplasm to nucleus, in the course of the activation process.

II.B Description of Assay

Indicator function methods can be applied to the analysis of cytoplasm-to-nucleus translocation assay images. In these assays, cells typically are visualized at two wavelengths, or two wavelength bands, corresponding to nuclear stain and to protein (translocatable) stain. The goal of the analysis is to quantify translocation of proteins between the cytoplasm and nucleus. Images representing extreme states of this assay are shown in FIG. 3-A,B,C.

The indicator function for the nucleus in the simplest case is the scaled nuclear stain image, as described above in section 1, and shown in FIG. 3 D. It also can be a smoothed nuclear image or any other derivative of the nuclear image that may be beneficial.

The total intensity or amount of stained protein in the nucleus can be calculated by computing the integral of image A weighted by image D over the area of the component containing the cell.

$$Amount = {\int }_{Image} Image A * Image D = {\sum }_{Allpixels} Image A ( i , j ) * Image D ( i , j )$$

For easier visualization, image A weighted by image D is shown as image G. Thus, the amount of stained protein in the nucleus is the sum of all pixels of G.

The average intensity or concentration of stained protein in the nucleus is another useful measure and can be calculated by dividing the sum of all pixels of G by the sum of all pixels of D.

$$Average = \frac{{\sum }_{Allpixels} Image G}{{\sum }_{Allpixels} Image D}$$

Two other compartments, in addition to the nucleus, that are useful to assess for this assay are the cytoplasm and the perinuclear region of cytoplasm (the “ring”). The indicator function for the cytoplasm is the complement of the indicator function for the nucleus within the compartment containing the cell (FIG. 3 E). The indicator function for the ring can be produced by dilating the indicator function for the nucleus by a given amount (width of the ring), subtracting the indicator function for the nucleus from the dilated function, and then normalizing the resulting function to the given scale, for example, as described above. Other methods of producing the indicator function for the ring may be used too. The amount of stained protein in the cytoplasm (ring) is the sum of all pixels of H (J). The average intensity of protein staining in the cytoplasm (ring) is the sum of all pixels of H (J) divided by the sum of all pixels of E (F).

Finally, a family of assay measures can be constructed as ratios of the total or average amounts of stained protein in the three compartments: N2C_T, N2C_A, N2R_T, N2R_A, where N stands for nucleus, C—for cytoplasm, R—for ring, A—for average, T—for total.

### III. EXAMPLES

This section describes, without limitation, further aspects and embodiments of the present teachings, presented as a series of numbered paragraphs.

1. A method of characterizing reporter position relative to biological cells, comprising: (a) acquiring image data from biological cells for each of at least two optically distinguishable reporters; (b) weighting the image data for a first reporter in a graded manner based on weight values defined by corresponding image data for a second reporter, to produce weighted data for the first reporter; and (c) calculating a measure of subcellular localization for the first reporter using at least a portion of the weighted data.

2. The method of paragraph 1, wherein the step of acquiring is performed with biological cells that include primary cells.

3. The method of paragraph 1, wherein the step of acquiring is performed with biological cells that include stem cells.

4. The method of paragraph 1, further comprising a step of labeling the biological cells to include the first reporter, the second reporter, or both.

5. The method of paragraph 4, wherein the step of labeling includes a step of contacting the biological cells with at least one dye that is a luminophore, a chromophore, or both.

6. The method of paragraph 4, wherein the step of labeling includes a step of transfecting the biological cells with a nucleic acid.

7. The method of paragraph 1, wherein the step of acquiring is performed individually for each reporter.

8. The method of paragraph 1, wherein the step of calculating a measure includes a step of calculating a measure of subcellular distribution of the first reporter between at least a pair of subcellular compartments.

9. The method of paragraph 8, wherein the step of calculating includes a step of calculating a measure related to a subcellular distribution of the first reporter between at least a pair of compartments of the biological cells selected from the group formed by nuclei, cytoplasm, plasma membranes, intracellular membranes, Golgi apparatus, mitochondria, cell surfaces, nucleoli, lysosomes, microtubules, intermediate filaments, actin filaments, and extracellular matrices.

10. The method of paragraph 8, wherein the step of calculating includes a step of calculating a measure related to a distribution of the first reporter between the nucleus and the cytoplasm of the biological cells.

11. The method of paragraph 1, wherein the image data includes a plurality of data elements corresponding to individual pixels of an image, and wherein the step of weighting is performed with corresponding pairs of data elements from image data of the first and second reporters.

12. The method of paragraph 1, further comprising a step of processing the image data for the second reporter to produce at least three different weight values, wherein the step of processing includes at least one of normalizing, averaging, and combining individual data elements of the image data for the second reporter.

13. The method of paragraph 1, wherein the step of weighting uses a first set of three or more different weight values to produce a first set of weighted data weighted toward a first subcellular compartment, further comprising a step of repeating the step of weighting using a second set of weight values on the image data of the first reporter, to produce a second set of weighted data weighted toward a second subcellular compartment, wherein the step of calculating uses at least a portion of both the first and second sets of weighted data to calculate a measure of subcellular distribution between the first and second subcellular compartments.

14. The method of paragraph 13, wherein the step of repeating the step of weighting results in a substantially complementary weighting of elements of the image data of the first reporter relative to the step of weighting.

15. The method of paragraph 13, wherein the step of acquiring is performed for at least a first, a second, and a third reporter, and wherein the step of repeating the step of weighting uses a second set of weight values define by image data for the third reporter.

16. The method of paragraph 1, further comprising a step of determining a perimeter for the biological cells, wherein the step of calculating is performed selectively with weighted data corresponding to inside the perimeter of the biological cells.

17. A method of testing for a translocation effect on biological cells, comprising: (a) exposing biological cells to a candidate modulator; (b) acquiring image data from the biological cells for each of at least two optically distinguishable reporters; (c) weighting elements of the image data for a first reporter using three or more different weight values defined by positionally corresponding image data for a second reporter, to produce weighted data for the first reporter; and (d) calculating a measure of first reporter position using at least a portion of the weighted data, to determine if exposure to the candidate modulator induces a change in the first reporter position and thus translocation of the first reporter.

18. The method of paragraph 17, wherein the steps of exposing, acquiring, weighting, and calculating are performed a plurality of times with different candidate modulators to screen the candidate modulators for actual modulators of first reporter position.

19. The method of paragraph 18, wherein the step of exposing is performed a plurality of times in distinct wells of a microplate.

20. The method of paragraph 17, wherein the step of exposing includes a step of contacting the biological cells with a mixture of two or more candidate modulators at the same time.

21. The method of paragraph 17, wherein the steps of exposing and acquiring are performed with biological cells that include primary cells.

22. The method of paragraph 17, wherein the step of exposing and acquiring are performed with biological cells that include stem cells.

23. The method of paragraph 17, further comprising a step of labeling the biological cells to include the first reporter, the second reporter, or both.

24. The method of paragraph 23, wherein the step of labeling is performed at least partially after the step of exposing.

25. The method of paragraph 23, wherein the step of labeling includes a step of contacting the biological cells with at least one dye that is a luminophore, a chromophore, or both.

26. The method of paragraph 23, wherein the step of labeling includes a step of transfecting the biological cells with a nucleic acid.

27. The method of paragraph 17, wherein the step of acquiring is performed individually for each reporter.

28. The method of paragraph 17, wherein the step of calculating a measure includes a step of calculating a measure corresponding to a subcellular distribution of the first reporter.

29. The method of paragraph 28, wherein the step of calculating includes a step of calculating a measure corresponding to a distribution of the first reporter between the nucleus and the cytoplasm of the biological cells.

30. The method of paragraph 17, wherein the image data includes a plurality of data elements corresponding to individual pixels of an image, and wherein the step of weighting is performed with corresponding pairs of data elements from image data of the first and second reporters.

31. The method of paragraph 17, further comprising a step of processing the image data for the second reporter to produce the different weight values, wherein the step of processing includes at least one of normalizing, averaging, and combining individual data elements of the image data for the second reporter.

32. The method of paragraph 17, wherein the step of weighting uses a first set of three or more different weight values to produce a first set of weighted data weighted toward a first subcellular compartment, further comprising a step of repeating the step of weighting using a second set of weight values for the image data of the first reporter, to produce a second set of weighted data weighted toward a second subcellular compartment, wherein the step of calculating uses at least a portion of both the first and second sets of weighted data to calculate a measure of subcellular distribution between the first and second subcellular compartments.

33. The method of paragraph 32, wherein the step of repeating the step of weighting results in a substantially inverse weighting of the elements of the image data for the first reporter relative to the step of weighting.

34. The method of paragraph 32, wherein the step of acquiring is performed for at least a first, a second, and a third reporter, and wherein the step of repeating the step of weighting uses a second set of weight values provided by image data for the third reporter.

35. The method of paragraph 17, further comprising a step of determining a perimeter for the biological cells, wherein the step of calculating is performed selectively with weighted data from inside the perimeter of the biological cells.

36. A method of testing candidate modulators for a translocation effect on biological cells, comprising: (a) exposing biological cells to a plurality of candidate modulators; (b) acquiring image data from the biological cells for each of at least two optically distinguishable reporters including a first reporter being tested for translocation between the nucleus and the cytoplasm and a second reporter selectively localized to a nuclear compartment or a cytoplasmic compartment, but not both, within the biological cells; (c) weighting the image data for the first reporter in a graded manner using three or more weight values defined by positionally corresponding image data for the second reporter, to produce weighted data for the first reporter; (d) calculating a measure of first reporter nuclear-cytoplasmic distribution by selectively using an intracellular portion of the weighted data for exposure to each of the plurality of candidate modulators; and (e) determining which, if any, of the plurality of candidate modulators induces translocation of the first reporter to the nucleus from the cytoplasm, or vice versa, based on the measures of nuclear-cytoplasmic distribution.

37. The method of paragraph 36, wherein the step of calculating includes a step of comparing the weighted data for exposure to a candidate modulator with corresponding image data of the first reporter that is weighted inversely.

38. The method of paragraph 37, wherein the step of comparing the weighted data includes a step of determining a ratio between the weighted data and corresponding image data of the first reporter that is weighted inversely.

39. The method of paragraph 36, wherein the step of determining includes a step of comparing the measures to a corresponding measure determined without exposure to a candidate modulator.

40. The method of paragraph 36, wherein the step of determining includes a step of comparing the measures to a corresponding measure determined with exposure to a known modulator of first reporter localization.

41. A system for characterizing reporter position for biological cells, comprising: (a) an optical imaging system configured to acquire image data from biological cells for each of at least two optically distinguishable reporters; and (b) a controller configured to weight the image data for a first reporter in a graded manner within each cell based on weight values defined by corresponding image data for a second reporter, to produce weighted data for the first reporter, and also configured to calculate a measure of first reporter subcellular localization using at least a portion of the weighted data.

42. A method of characterizing reporter distribution for biological cells, comprising: (a) acquiring image data from biological cells for a reporter; (b) processing the image data to create a pair of data representations for a pair of images with overlapping signals indicating respective localization of the reporter to distinct subcellular compartments; and (c) calculating a measure of subcellular localization for the reporter based on the data representations.

43. The method of paragraph 42, wherein acquiring image data includes a step of acquiring image data from a reporter component or reporter structure that occurs naturally in the biological cells.

The disclosure set forth herein may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein and may be combined, optionally, with apparatus, methods, compositions, and/or kits, or components thereof, described in the various references listed above under Cross-References and incorporated herein by reference.

1. A method of characterizing reporter position relative to biological cells, comprising:
acquiring image data from biological cells for each of at least two optically distinguishable reporters;
weighting the image data for a first reporter in a graded manner based on weight values defined by corresponding image data for a second reporter, to produce weighted data for the first reporter; and
calculating a measure of subcellular localization for the first reporter using at least a portion of the weighted data.

2. The method of claim 1, wherein the step of acquiring is performed with biological cells that include primary cells and/or stem cells.

3. The method of claim 1, further comprising a step of labeling the biological cells to include the first reporter, the second reporter, or both, wherein the step of labeling includes (1) a step of contacting the biological cells with at least one dye that is a luminophore, a chromophore, or both, and/or (2) a step of transfecting the biological cells with a nucleic acid.

4. The method of claim 1, wherein the step of acquiring is performed individually for each reporter.

5. The method of claim 1, wherein the step of calculating a measure includes a step of calculating a measure of subcellular distribution of the first reporter between at least a pair of subcellular compartments selected from the group formed by nuclei, cytoplasm, plasma membranes, intracellular membranes, Golgi apparatus, mitochondria, cell surfaces, nucleoli, lysosomes, microtubules, intermediate filaments, actin filaments, and extracellular matrices.

6. The method of claim 1, wherein the step of calculating includes a step of calculating a measure related to a distribution of the first reporter between the nucleus and the cytoplasm of the biological cells.

7. The method of claim 1, wherein the image data includes a plurality of data elements corresponding to individual pixels of an image, and wherein the step of weighting is performed with corresponding pairs of data elements from image data of the first and second reporters.

8. The method of claim 1, further comprising a step of processing the image data for the second reporter to produce at least three different weight values, wherein the step of processing includes at least one of normalizing, averaging, and combining individual data elements of the image data for the second reporter.

9. The method of claim 1, wherein the step of weighting uses a first set of three or more different weight values to produce a first set of weighted data weighted toward a first subcellular compartment, further comprising a step of repeating the step of weighting using a second set of weight values on the image data of the first reporter, to produce a second set of weighted data weighted toward a second subcellular compartment, wherein the step of calculating uses at least a portion of both the first and second sets of weighted data to calculate a measure of subcellular distribution between the first and second subcellular compartments.

10. The method of claim 9, wherein the step of repeating the step of weighting results in a substantially complementary weighting of elements of the image data of the first reporter relative to the step of weighting.

11. The method of claim 9, wherein the step of acquiring is performed for at least a first, a second, and a third reporter, and wherein the step of repeating the step of weighting uses a second set of weight values define by image data for the third reporter.

12. The method of claim 1, further comprising a step of determining a perimeter for the biological cells, wherein the step of calculating is performed selectively with weighted data corresponding to inside the perimeter of the biological cells.

13. The method of claim 1, further comprising (1) a step of exposing the biological cells to a candidate modulator, and (2) a step of determining if exposure to the candidate modulator induces a change in first reporter subcellular localization and thus translocation of the first reporter.

14. The method of claim 13, wherein the steps of exposing, acquiring, weighting, and calculating are performed a plurality of times with different candidate modulators to screen the candidate modulators for actual modulators of first reporter subcellular localization.

15. The method of claim 13, wherein the step of exposing includes a step of contacting the biological cells with a mixture of two or more candidate modulators at the same time.

16. A method of testing candidate modulators for a translocation effect on biological cells, comprising:
exposing biological cells to a plurality of candidate modulators;
acquiring image data from the biological cells for each of at least two optically distinguishable reporters including a first reporter being tested for translocation between the nucleus and the cytoplasm and a second reporter selectively localized to a nuclear compartment or a cytoplasmic compartment, but not both, within the biological cells;
weighting the image data for the first reporter in a graded manner using three or more weight values defined by positionally corresponding image data for the second reporter, to produce weighted data for the first reporter; and
calculating a measure of first reporter nuclear-cytoplasmic distribution by selectively using an intracellular portion of the weighted data for exposure to each of the plurality of candidate modulators; and
determining which, if any, of the plurality of candidate modulators induces translocation of the first reporter to the nucleus from the cytoplasm, or vice versa, based on the measures of nuclear-cytoplasmic distribution.

17. The method of claim 16, wherein the step of calculating includes a step of comparing the weighted data for exposure to a candidate modulator with corresponding image data of the first reporter that is weighted inversely.

18. A method of characterizing reporter distribution for biological cells, comprising:
acquiring image data from biological cells for a reporter;
processing the image data to create a pair of data representations for a pair of images with overlapping signals indicating respective localization of the reporter to distinct subcellular compartments; and
calculating a measure of subcellular localization for the reporter based on the data representations.

19. The method of claim 18, wherein acquiring image data includes a step of acquiring image data from a reporter component or reporter structure that occurs naturally in the biological cells.

20. The method of claim 18, further comprising a step of determining a perimeter for the biological cells, wherein the step of calculating is performed substantially exclusively with data representations disposed within the perimeter.
